(19) United States
(12) Patent Application Publication
(10) Pub. No.: US 2008/0014364 A1
(43) Pub. Date: Jan. 17, 2008

(54) Water-Vapor Assisted Lacquering Method

(76) Inventor: Gerhard Brendel, Auerbach (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/598,907

(22) PCT Filed: Mar. 16, 2005
(86) PCT No.: PCT/EP05/02811

§ 371 Date: Apr. 3, 2007

(30) Foreign Application Priority Data
Mar. 16, 2004 (DE) 10 2004 012 889.8

(51) Int. Cl. B05D 1/02

(52) U.S. Cl. 427/475; 118/626

(57) ABSTRACT

The invention relates to a method or a system for coating substrates with at least one coating material which comprises at least one organic component, wherein the coating material is applied to the substrate by means of atomization and spray-painting. The invention is characterized in that the coating material is atomized by means of water vapor.

The invention also relates to a system for coating substrates, wherein at least one nozzle arrangement (1) is provided in order to a atomize and spray the coating material onto a substrate, and at least one first supply device (8) which is used to prepare and supply the coating material to the nozzle arrangement (1), in addition to at least one second supply device (9) which is used to prepare and supply the steam as auxiliary gas to the nozzle arrangement (1).

### FIELD OF THE INVENTION

The present invention relates to a method for coating substrates and a corresponding system.

### BACKGROUND OF THE INVENTION

Many objects in daily use, miscellaneous consumer goods as well as objects used commercially or industrially derive their external appearance only through the agency of a coating, said coating capable of being used both for aesthetic reasons and to provide a protective function. A widespread coating possibility is afforded by coating methods in which a film, the so-called paint, which adheres on, protects and, perhaps, decorates a substrate is generated with the aid of a coating material based on an organic binder. Such a coating material contains pigments, fillers, additives and/or solvents or dispersing agents in addition to macromolecular film-forming agents or film-forming agents that form macromolecules. By solvents here is meant all liquids or liquid mixtures, such as alcohols and water, that are capable of dissolving the film-forming agent(s). By “dispersing agent” is meant those liquids such as hydrocarbons and water which, although they do not dissolve the film-forming agent, keep it in a fine, micro-heterogeneous distribution.

Such coating materials, which may generally be termed paints, may be applied to the objects or substrates for coating by the most diverse methods. Examples of these are dip coating, painting and spraying.

Spraying techniques are of major importance in industrial use because they facilitate automated and industrial production featuring particularly uniform paint formation. In spraying methods, the coating material to be applied to the substrate is atomized by different methods into a plurality of small droplets which are then deposited uniformly on the substrate where they coalesce again to form a film. An example of a known atomization method consists of driving the coating material through an arrangement of nozzles, after which, having left the nozzle, it is shredded into many small droplets. In this connection, either the coating material itself is forced under corresponding pressure through the nozzle arrangement (hydraulic) or the coating material is atomized by means of compressed air (pneumatic), with the compressed air exiting the nozzle arrangement together with the coating material.

The present invention relates to the application of paints to substrates by means of spraying methods in which the coating material is atomized by a nozzle arrangement, such as a paint gun.

The problem with these known methods, especially in regard to the application of water-based paints in which water serves as the solvent or dispersing agent, is that air occlusions in the case of pneumatic atomization prevent a homogeneous coating from being achieved on the substrate surface. Especially in the case of substrates with a high surface tension, such as plastics, islands with an absence of coating material occur in the paint film on the substrate. This is especially problematic if the coating consists of several layers and islands form already in the base coat or prime coat since these then are propagated in the subsequent layers. Island formation is observed especially when plastics are coated with so-called adhesion promoters (primers) having a very high water content and a low solids content.

It is therefore the object of the present invention to provide a method for applying paints to substrates that avoids the problem of island formation during paint application. At the same time, this method is to be simple and economical to use, without the need for major changes to existing painting equipment.

### SUMMARY OF THE PRESENT INVENTION

With the present invention it was surprisingly found that the aforementioned problems of island formation, especially during application of water-based paints to plastics, can be simply avoided by using water vapor as the auxiliary gas during pneumatic atomization instead of air. This avoids the air occlusions in the paint and the resultant formation of islands in the paint layer. Moreover, this method is easy to realize since only water vapor need be used instead of the air, with the result that existing machinery can largely continue to be used. All that is needed is for certain water-vapor feed lines or seals to be appropriately designed such that they can permanently withstand water-vapor. Ceramic seals in the paint guns, for example, lend themselves to this. From a machinery point of view, it is only necessary to provide an additional device to generate water vapor.

Preferably, the water vapor may be used in the low pressure range of 0.5 to 2 bar or in the high pressure range from 2 to 10, especially 4 to 8 bar.

Aside from water-based paints in which water is the solvent or dispersing agent, the use of water vapor also as an auxiliary gas for pneumatic spraying of essentially solvent-free hot melt paint has proven itself since, in the case of these paints, which consist almost of 100 percent solids, the heated water-vapor does not effect cooling of the melted paint during spraying, or even additional heating or warming of the melt paint for liquefaction can be dispensed with.

Aside from the use of the method of the invention for the application of, especially, primers to plastics, it goes without saying that this method can naturally be used for corresponding top coats, filler layers or clearcoat layers on metals or wood materials as well.

Preferably, a device for avoiding water droplets in the water vapor is provided close to the nozzle opening in the spray gun. This may be formed by a pressure-increasing device and/or a heating device. The arrangement is to be chosen such that virtually pure water vapor is available at the nozzle opening. Correspondingly, the length of the heating device or its rating/performance must be chosen such that an adequate temperature increase is attained. The same applies to the pressure-increasing device with regard to the change in pressure.

### BRIEF DESCRIPTION OF DRAWINGS

Further advantages, characteristics and features of the present invention are apparent from the following detailed description of an embodiment using the enclosed drawings. The purely schematic drawings show in

FIG. 1 a) and b) are schematic diagrams of nozzle arrangements with internal mixing (a) and external mixing (b) of the coating material with the water vapor used as auxiliary gas for application;

FIG. 2 is a schematic diagram of a system for coating substrates in accordance with the present invention;

FIG. 3 is a schematic diagram of the water-vapor feed line in the spray gun; and

FIG. 4 is a schematic diagram of a second embodiment of the water-vapor feed line in the spray gun.

### DETAILED DESCRIPTION OF THE PREFERRED EMBODIMENT

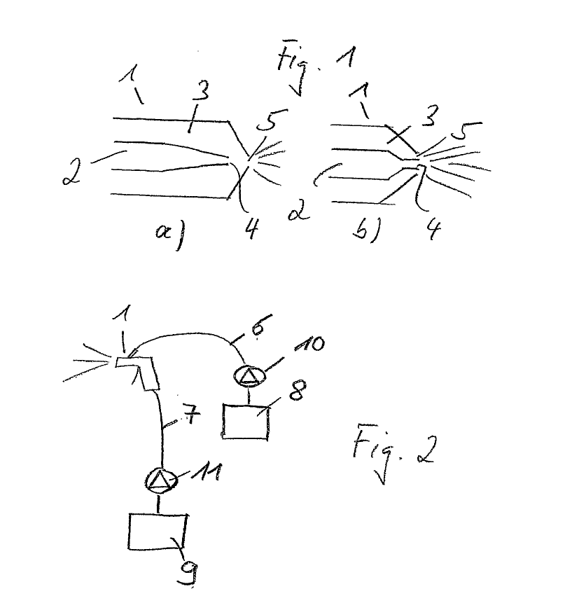

FIG. 1 shows in two schematic diagrams two different nozzle arrangements 1, which, for example, can be realized in a spray gun in order that the method of the invention may be performed.

In the nozzle arrangement 1 of sub-diagram a), the nozzle arrangement has an inner nozzle 2 and an outer nozzle 3, with the nozzle opening 4 of the inner nozzle 2 arranged inside the outer nozzle arrangement 3 directly in front of the nozzle opening 5 of the outer nozzle arrangement 3. In this way, the coating material transported in the internal nozzle arrangement 2 is mixed with the water vapor transported in the outer nozzle arrangement 3 prior to finally leaving the nozzle arrangement 1 through the nozzle opening 5 of the outer nozzle arrangement 3 (internal mixing).

As opposed to this, in the nozzle arrangement 1 of sub-diagram b), in which the nozzle opening 4 of the inner nozzle arrangement 2 is arranged at the same level as the nozzle opening 5 of the outer nozzle arrangement 3, mixing of the coating material located in the inner nozzle arrangement 2 with the water vapor, which has left the outer nozzle arrangement 3 through the nozzle opening 5, occurs only after said coating material has left nozzle arrangement 1 (external mixing).

These two types of spray coating of the coating material with the aid of water vapor can be used for the present invention.

FIG. 2 is a purely schematic drawing of a system for coating substrates in accordance with the present invention, wherein a nozzle arrangement 1 is connected in accordance with the nozzle arrangements of FIG. 1 via a first feed line 6 to a first supply device 8 for providing and feeding the coating material to the nozzle arrangement 1, with the coating material being conveyed in the feed line 6 by a pump 10.

The nozzle arrangement 1 is further connected via a second feed line 7 to a second supply device 9 which comprises a water-vapor generator, by means of which the water vapor required for the invention can be generated and conveyed to the spray gun 1.

As part of the second supply device 9 or, as shown in FIG. 2, as a separate device, a pressure-increasing or compression device, such as a pump 11, may be provided in the second line 7 to bring the water vapor to the corresponding operating pressure range of 0.5 to 10 bar or 1 to 2 or 4 to 8 bar.

In the same way, it goes without saying that the corresponding pressure-increasing or compression device or pump 10 may also be integrated in the first supply device for the coating material or be provided separately in the first supply line 6 (as illustrated).

It goes without saying that the pump 10 in the supply line 6 for the coating material can also be dispensed with if the suction of the water vapor ensures adequate transport of the coating material.

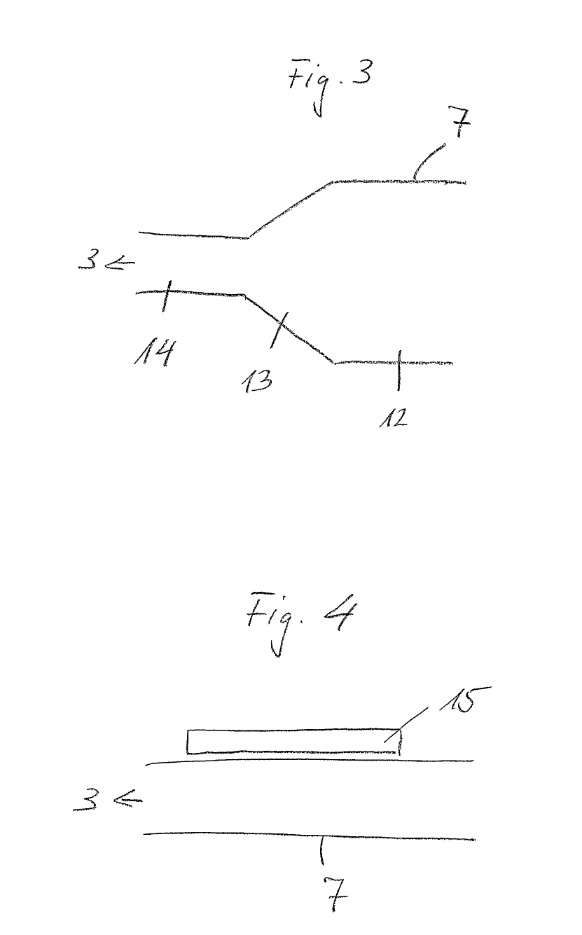

FIGS. 3 and 4 schematically show the preferred embodiments of the nozzle arrangement 1 and the water-vapor feed line 7.

In accordance with FIG. 3, the cross section of the feed line is reduced in the vicinity of the delivery opening or nozzle opening 5 such that the pressure directly in front of the nozzle opening 5 increases, so that even the tiniest quantities of water droplets, which may have precipitated out of the water vapor, are vaporized again and thus almost pure water vapor is available for application of the coating material. In the embodiment shown in FIG. 3, this is achieved by a conical region 13 in the feed line 7, said conical region reducing the first cross section of the line 7 in region 12 to a second cross section in region 14.

FIG. 4 shows a further possibility for counteracting the formation of water droplets in the water vapor. For this purpose, an additional heating device 15 is provided directly in front of or at the nozzle opening 5, by means of which said device the water vapor can be correspondingly heated and superheated such that all of the water is present in water vapor form. All known devices, such as electrical resistance heaters with windings around line 7 or cartridge heaters with exothermic materials or fuels for use in a cavity of the spray gun, can serve as the heating device 15.

1-10. (canceled)

11. Method for coating substrates with at least one coating material comprising providing at least one organic component and applying the coating material to the substrate by atomization and spraying, wherein the coating material is atomized by water vapor.

12. Method in accordance with claim 11, wherein the coating material is a water-based paint or an essentially solvent-free hot melt paint.

13. Method in accordance with claim 11, wherein the coating material is applied as primer, top coat, filler or clearcoat.

14. Method in accordance with claim 11, wherein the coating material, by flowing through a nozzle arrangement, is atomized with the water vapor acting as auxiliary gas and is sprayed onto the substrate.

15. Method in accordance with claim 11, wherein the water vapor flows out of a nozzle arrangement, with or adjacent to the coating material, with the water vapor of the nozzle arrangement being fed at a pressure of 0.5 to 10 bar.

16. Method in accordance with claim 11, wherein metals, plastics or wood materials are used as the substrate.

17. A system for coating substrates in accordance with claim 11, with at least one nozzle arrangement for atomizing and spraying the coating material onto the substrate and including at least a first supply device for providing and feeding the coating material to the nozzle arrangement and at least a second supply device for preparing and feeding an auxiliary gas to the nozzle arrangement for atomizing the coating material, wherein the second supply device comprises a water-vapor generator.

18. System in accordance with claim 17, wherein the second supply device and/or a feed line to the nozzle arrangement comprises a pressure-increasing or compression device, with which the water vapor can be brought to operating pressure in the range of 0.5 to 10 bar.

19. System in accordance with claim 7, wherein the spray gun has a heating device and/or a pressure-increasing device for converting nearly all of the water into the vapor phase.

20. System in accordance with claim 17, wherein the pressure-increasing device is formed by a reduction in cross section of a feed line.
